(19) United States
(12) Patent Application Publication
(10) Pub. No.: US 2015/0298347 A1
(43) Pub. Date: Oct. 22, 2015

(54) WOOD POLYMER/PLASTIC COMPOSITE MATERIAL AVAILABLE FOR DIRECT CONNECTION CONSTRUCTION AND METHOD FOR MANUFACTURING SAME

(71) Applicant: LG HAUSYS, LTD., Seoul (KR)

(72) Inventors: Jae Youl JOUNG, Daejeon (KR); Jung II SON, Yongin-si (KR)

(21) Appl. No.: 14/423,629

(22) PCT Filed: Sep. 4, 2013
(86) PCT No.: PCT/KR2013/007976

§ 371 Date: Feb. 24, 2015

(30) Foreign Application Priority Data
Sep. 6, 2012 (KR) 10-2012-0098598

(51) Int. Cl. B27N 3/08; C08J 5/00; B27N 3/00; B27N 3/02; B27N 3/04

(52) U.S. Cl. CPC B27N 3/08; B27N 3/02; B27N 3/04; B27N 3/002; C08J 5/00; C08J 2321/00; C08J 2421/00; C08J 2301/02; C08J 2401/02

(57) ABSTRACT

The present invention relates to a wood polymer/plastic composite that includes a rubber-based material in addition to wood powder used as a principal ingredient to improve on the physical characteristics such as compression strength, impact strength, or the like and have better dimensional stability, thereby providing solutions to the direct nailing process.

The present invention to achieve the object includes: pulverizing wood logs or wood flake chips to prepare a wood powder as a principal ingredient; adding a rubber-based material and additives to the wood powder and mixing together to prepare a compound; and preparing a wood polymer/plastic composite from the compound through any one method of extrusion, injection or press molding.

The present invention adds wood flake chips and long fibers excellent in elongation and strength and a rubber-based material in addition to the wood powder used as a principal ingredient in the manufacture of a wood polymer/plastic composite, to realize the respective polymer characteristics, consequently with better formability and improved properties of the product such as dimensional stability, thereby enabling the direct nailing process of the wood polymer/plastic composite.

### BACKGROUND OF THE INVENTION

1. Field of the Invention

The present invention relates to a wood polymer/plastic composite and, more particularly, to a wood polymer/plastic composite that improves on the physical characteristics such as compression strength, impact strength, or the like to provide solutions to the direct nailing process by including a rubber-based material and has higher dimensional stability by including wood flake chips or long fibers.

2. Background Art

Generally, wood is a material widely used as a natural material. But it is vulnerable to water and requiring high maintenance expense against cracking and rupture occurring with an elapse of time. A solution to the weaknesses of the wood is wood polymer/plastic composite (WPC).

The wood polymer/plastic composite has almost no discoloration or deformation such as cracks or ruptures, which are the problems with the ordinary wood. Particularly, the wood polymer/plastic composite, unlike the natural wood, is highly resistant to water and thus not readily rotten even when used as an exterior material. With such strengths, the wood polymer/plastic composite has replaced natural woods and treated woods, so the breadth of its market continues to grow.

In comparison with the natural wood, however, the wood polymer/plastic composite has restrictions on the direct nailing process to impose inconvenience in construction. In other words, direct nailing refers to the process of installing nails to join woods together, and the conventional wood polymer/plastic composite under the nailing process is problematically susceptible to damages on the nailed portion and its peripheral portion. With this problem, the wood polymer/plastic composite can be applied in construction only by using clips in place of nailing. This imposes limitations on the construction method of the wood polymer/plastic composite and requires high expertise in the construction, consequently with limited demands for the wood polymer/plastic composite.

Accordingly, there has been a demand for improving the material used in the manufacture of wood polymer/plastic composites that provides a solution to enable the direct nailing process.

### SUMMARY OF THE INVENTION

The present invention is derived to solve the problems with the prior art, and its object is to provide a wood polymer/plastic composite that presents a solution to enable the direct nailing process not only by including a rubber-based material in addition to the wood powder used as a principal ingredient to enhance the physical characteristics such as compression strength and impact strength but also by containing wood flake chips and long fibers excellent in elongation and strength in addition to the wood powder to improve dimensional stability.

To achieve the object of the present invention, there is provided a method for manufacturing a wood polymer/plastic composite that includes: pulverizing wood logs or wood flake chips to prepare a wood powder as a principal ingredient; adding a rubber-based material and additives to the wood powder and mixing together to prepare a compound; and preparing a wood polymer/plastic composite from the compound through any one method of extrusion, injection or press molding.

In this case, the wood powder is dried in a drier at 80 to 120° C. to have a water content of 5 to 15 wt %.

The compound may further include wood flake chips and/or long fibers.

The compound may include 10 to 80 wt % of the wood powder, the wood flake chips and the long fibers and 10 to 40 wt % of the rubber-based material.

The rubber-based material may include at least one selected from the group consisting of synthetic rubber, natural rubber, and reclaimed rubber (e.g., waste tires, elastic blocks, etc.).

Further, the compound may optically include, as additives, 0.1 to 50 wt % of a compatibilizer, 0.1 to 50 wt % of a filler, 0.1 to 30 wt % of an antioxidizer 0.1 to 30 wt % of a lubricant, and 0.1 to 30 wt % of a pigment.

The wood flake chips are cut to a length of 0.5 to 18 cm.

The long fibers may include at least one selected from the group consisting of natural fibers, including corn fiber, coconut fiber, palm tree fiber, reed, bamboo, rice straw, cotton, bast fiber, wool, or silk; reinforced polymer fibers, including glass fiber, carbon fiber, or nylon; and steel wire.

The wood polymer/plastic composite according to the present invention may be prepared according to any one of the manufacturing methods.

The present invention according to the above-described composition includes a rubber-based material in addition to the wood powder used as a principal ingredient to enhance the physical characteristics, such as compression strength, impact strength, or the like, thereby enabling the direct nailing process, and also contains wood flake chips and long fibers excellent in elongation and strength as well as the wood powder to improve dimensional stability, so it can provide a solution to the problem with the conventional wood polymer/plastic composites in regards to the difficulty of the direct nailing process.

### DETAILED DESCRIPTION OF THE PREFERRED EMBODIMENT

Hereinafter, a detailed description will be given as to the preferred embodiments of the present invention as follows.

The method for manufacturing a wood polymer/plastic composite according to the present invention includes:

pulverizing wood logs or wood flake chips to prepare a wood powder as a principal ingredient; adding a rubber-based material and additives to the wood powder and mixing together to prepare a compound; and preparing a wood polymer/plastic composite from the compound through any one method of extrusion, injection or press molding.

In other words, the present invention adds a rubber-based material and additives in addition to the wood powder used as a principal ingredient in the manufacture of a wood polymer/plastic composite to enhance the physical characteristics, such as compression strength, impact strength, or the like, thereby enabling the direct nailing process.

In this regard, the wood powder is subjected to a drying process so that it is dried in a drier at 80 to 120° C. to have a water content of 5 to 15 wt %. The drying temperature for the wood powder lower than 80° C. makes it require too much time in drying the wood powder, while the drying temperature above 120° C. leads to rapid drying to warp the dense tissue of the wood powder, which is also called “deformation”.

The wood powder is dried to maintain the water content of 5 to 15 wt %, in which case it can be mixed well with other ingredients without adding a separate binder. Contrarily, the water content above 15 wt % ends up with the water in the wood powder vaporized during the manufacture of the wood polymer/plastic composite to leave air bubbles that weaken the binding strength of the ingredients in the mixing step. This leads to defective products.

Also, the compound may further include wood flake chips and long fibers. In this case, the wood flake chips are preferably cut to a length of 0.5 to 18 cm, more preferably 3 to 8 cm. When the wood flake chips are cut to a length of less than 0.5 cm, there is no difference from the case of using the existing wood powder as a principal ingredient, and it is thus impossible to enhance the physical characteristics such as compression strength and impact strength. Contrarily, when the wood flake chips are cut to a length of greater than 18 cm, there is a difficulty of mixing the wood flake chips with the rubber-based material and performing the molding process. More preferably, the wood flake chips are cut to a length of 3 to 8 cm. The wood flake chips cut to a length within the above-defined range leads to high enhancement of the physical characteristics such as compression strength or impact strength and best facilitates their compatibility with other ingredients and the molding process.

In addition, the long fibers are preferably cut to a length of 0.5 to 18 cm. When the long fibers are cut to a length of less than 0.5 cm, there is no difference from the case of using the existing wood powder as a principal ingredient, and it is impossible to enhance the physical characteristics such as compression strength and impact strength. Contrarily, when the long fibers are cut to a length of greater than 18 cm, there is a difficulty of mixing the long fibers with the rubber-based material and performing the molding process. However, the long fibers can be molded without any limit in their length out of the above-defined range only when they are molded in parallel with the lengthwise direction of the wood polymer/plastic composite during the extrusion molding process which is used as the molding method for the wood polymer/plastic composite.

Further, the long fibers may include at least one selected from the group consisting of natural fibers, including corn fiber, coconut fiber, palm tree fiber, reed, bamboo, rice straw, cotton, bast fiber, wool, silk, etc.; reinforced polymer fibers, including glass fiber, carbon fiber, nylon, etc.; and steel wire.

The formability of the wood polymer/plastic composite becomes higher with the lower water content of the wood flake chips or the long fibers. For example, a defined drying process is preferably performed to maintain the water content of the wood flake chips and the long fibers in the range of 5 to 15 wt % as the water content of the wood powder.

After the completion of the cutting and drying processes, the wood flake chips and the long fibers are mixed with a rubber-based material and additives to form a compound.

In this regard, the rubber-based material may include at least one selected from the group consisting of synthetic rubber, natural rubber, and reclaimed rubber (waste tires or elastic blocks).

Here, the compound is prepared by adding 10 to 80 wt % of the wood powder, the wood flake chips and the long fibers, 10 to 40 wt % of a rubber-based material, and optionally additives including 0.1 to 50 wt % of a compatibilizer, 0.1 to 50 wt % of a filler, 0.1 to 30 wt % of an antioxidizer 0.1 to 30 wt % of a lubricant, and 0.1 to 30 wt % of a pigment into a mixer and then mixing them for a defined period of time. More preferably, the compound includes 50 to 80 wt % of the wood powder, the wood flake chips and the long fibers, 10 to 40 wt % of the rubber-based material, and 10 wt % or less of other additives.

On the other hand, the wood powder has the greater surface area per unit particle than the wood flake chips and, when included in an extremely large amount in the compound, makes the compound stiff to lower the liquidity of the raw material, leading to poor workability. Hence, the content of the wood powder in the compound is preferably 60 wt % or less.

Once prepared, the compound is subjected to a defined molding process to form a wood polymer/plastic composite. In this regard, the present invention preferably performs the molding process for the wood polymer/plastic composite using an extrusion molding method. But the wood polymer/plastic composite may be manufactured, without limitation in the molding method, by using a molding process such as injection molding, press molding, or the like.

The wood polymer/plastic composite thus manufactured through the molding process may be used as an exterior material for buildings, a roofing material, a fence/deck material for homes, a flooring material for side walk, and so forth.

The high strength wood polymer/plastic composite according to the present invention not only improves in the physical characteristics such as compression strength, impact strength, or the like but also becomes lightweight by adding wood flake chips and long fibers cut to a defined length in addition to the wood powder in a compound.

Further, the wood polymer/plastic composite can realize the respective polymer characteristics to achieve better formability and improve on the properties of the product such as dimensional stability by adding a rubber-based material and additives to the compound at a defined proportion. Accordingly, this enables the direct nailing process of the wood polymer/plastic composite.

The above description of the present disclosure is provided for the purpose of illustration, and the above-described embodiments do not limit the present disclosure. It would be understood by those skilled in the art that various changes and modifications may be made without changing technical conception of the present disclosure.

1. A method for manufacturing a wood polymer/plastic composite, comprising:
pulverizing wood logs or wood flake chips to prepare a wood powder as a principal ingredient;
adding a rubber-based material and additives to the wood powder and mixing together to prepare a compound; and
preparing a wood polymer/plastic composite from the compound through any one method of extrusion, injection or press molding.

2. The method as claimed in claim 1, wherein the wood powder is dried in a drier at 80 to 120° C. to have a water content of 5 to 15 wt %.

3. The method as claimed in claim 1, wherein the compound further comprises wood flake chips.

4. The method as claimed in claim 3, wherein the wood flake chips are cut to a length of 0.5 to 18 cm.

5. The method as claimed in claim 3, wherein the wood flake chips are cut to a length of 3 to 8 cm.

6. The method as claimed in claim 3, wherein the compound further comprises long fibers.

7. The method as claimed in claim 6, wherein the long fibers comprise at least one selected from the group consisting of natural fibers, including corn fiber, coconut fiber, palm tree fiber, reed, bamboo, rice straw, cotton, bast fiber, wool, or silk;
reinforced polymer fibers, including glass fiber, carbon fiber, or nylon; and steel wire.

8. The method as claimed in claim 7, wherein the long fibers are cut to a length of 0.5 to 18 cm.

9. The method as claimed in claim 6, wherein the compound comprises 10 to 80 wt % of the wood powder, the wood flake chips and the long fibers and 10 to 40 wt % of the rubber-based material.

10. The method as claimed in claim 6, wherein the compound comprises 50 to 80 wt % of the wood powder, the wood flake chips and the long fibers and 10 to 40 wt % of the rubber-based material

11. The method as claimed in claim 1, wherein the rubber-based material comprises at least one selected from the group consisting of synthetic rubber, natural rubber, and reclaimed rubber.

12. A wood polymer/plastic composite prepared according to the method as claimed in claim 1.
